(19) United States
(12) Patent Application Publication
(10) Pub. No.: US 2007/0060047 A1
(43) Pub. Date: Mar. 15, 2007

(54) Repeater

(76) Inventor: Mitsuhiro Ono, Kawasaki (JP)

Correspondence Address: KATTEN MUCHIN ROSENMAN LLP, 575 MADISON AVENUE, NEW YORK, NY, 10022-2585, US

(21) Appl. No.: 10/570,577

(22) PCT Filed: Oct. 2, 2003
(86) PCT No.: PCT/JP03/12670

§ 371 Date: Mar. 2, 2006

(51) Int. Cl. H04B 7/15

(52) U.S. Cl. 455/11.1

(57) ABSTRACT

A repeater used in a radio communication system and a radio transmission system locally forms in a blind zone a wireless zone in which these systems can be accessed. The repeater is capable of properly allocating a radio resource to a blind zone and a non-blind zone without having a very complex structure. Thus, the repeater has a first monitor unit that monitors a first radio signal received through a radio transmission path, a retransmission unit that retransmits said first radio signal, and a control unit that decreases an output power of the retransmission unit by setting a gain thereof to a small value when said first monitor unit detects a large load of a transmission source of said first radio signal.

### CROSS REFERENCE TO RELATED APPLICATION

This application is a continuation application of International Application PCT/JP03/12670, filed Oct. 2, 2003, and designating the U.S.

### BACKGROUND OF THE INVENTION

1. Field of the Invention

The present invention relates to a repeater that is used in a radio communication system and a radio transmission system and locally forms a wireless zone in a blind zone that occurs due to ground structures and land forms, in order to allow these systems to be accessible.

2. Description of the Related Art

In a mobile communication system, a radio base station forms a wireless zone in an area where terminals can be located. Radio channels are allocated between the radio base station and individual terminals under a predetermined channel control.

In such a wireless zone, a blind zone may occur in which ground structures such as high-rise buildings and land forms such as hills prevent radio frequency signals from propagating, preventing radio transmission paths with high transmission quality from being formed between the radio base station and terminals.

Conventionally, a terminal located in such a blind zone is provided with a communication service through a repeater that extends a desired wireless zone to the blind zone.

FIG. 7 shows an example of a structure of a CDMA mobile communication system that is provided with a repeater.

In the drawing, a radio base station 71 forms a wireless zone 72. A repeater 80 is installed at a location adjacent to a blind zone 73 to be contained in the wireless zone 72.

The repeater 80 is composed of the following elements:

An antenna 81 whose main robe direction is directed toward the radio base station 71,

A circulator 82 whose first opening is connected to a feeding point of the antenna 81,

A band-pass filter (BPF) 83d, a variable attenuator (ATT) 84d, and a power amplifier 85d that are tandem-connected to a second opening of the circulator 82,

A circulator 86 whose first opening is connected to an output of the power amplifier 85d,

An antenna 87 whose feeding point is connected to a second opening of the circulator 86 and whose main robe is directed toward the blind zone 73, and

A band-pass filter (BPF) 83u, a variable attenuator (ATT) 84u, and a power amplifier 85u that are tandem-connected between a third opening of the circulator 86 and a third opening of the circulator 82.

In the repeater 80, reception waves that are transmitted from the radio base station 71 and that arrive at the antenna 81 (hereinafter, these reception waves are referred to as downstream signals) are supplied to the band-pass filter 83d through the circulator 82. The band-pass filter 83d suppresses components of radio frequency signals that arrive at the antenna 81 along with the downstream signals and that cause interference and disturbance with the downstream signals through a pass band set to an occupied band thereof. The attenuation degree of the variable attenuator 84d is set so that the sum of transmission losses of the downstream signals over a region from the radio base station 71 to the antenna 81 is to be a predetermined value. The attenuation degree of the variable attenuator 84d is, for example, set at a difference between the predetermined value and the reception level (RSCP) of the downstream signals that arrive at the antenna 81 through a CPICH. Thus, a signal of the downstream signals received through the CPICH is supplied to the power amplifier 85d in a predetermined level by the variable attenuator 84d.

The power amplifier 85d amplifies the downstream signals and reradiates them in a predetermined level toward the blind zone 73 through the circulator 86 and the antenna 87.

Thus, in the blind zone 73, the downstream signals broadcast from the radio base station 71 are remarkably attenuated or blocked by land forms and ground structures. However, the repeater 80 locally provides a wireless zone that allows for a communication service in desired transmission quality between the blind zone 73 and the radio base station 71.

In addition, the repeater 80 is normally designed so that the maximum level of the downstream signals that can be broadcast toward the blind zone 73 by the repeater 80 is 1/20 to 1/10 as small as the level of the downstream signals broadcast by the radio base station 71.

Radio frequency signals that are transmitted from terminals that are located in the blind zone 73 and that arrive at the antenna 87 (hereinafter these signals are referred to as the upstream signals) are relayed (retransmitted) to the radio base station 71 through the band-pass filter 83u, the variable attenuator 84u, and the power amplifier 85u.

It is assumed that radio channels used to transmit the downstream signals (hereinafter these radio channels are referred to as the down-bound radio channels) and radio channels used to transmit the upstream signals (hereinafter these radio channels are referred to as the up-bound radio channels) are composed of a combination of the following channels.

[Down-Bound Radio Channels]

PCCPCH (Primary Common Control Physical Channel) that is used to transmit information and whose transmission power is not controlled (transmission power is constant) (FIG. 8a (1)),

SCCPCH (Secondary Common Control Physical Channel) that is used to page a terminal and whose transmission power is not controlled (transmission power is constant) (FIG. 8a (2)),

AICH (Acquisition Indication Channel) that is used to facilitate a random access control and whose transmission power is not controlled (transmission power is constant) (FIG. 8a (3)),

PICH (Page Indication Channel) that is in parallel with SCCPCH as a pair and whose transmission power is not controlled (transmission power is constant) (FIG. 8a (4)),

CPICH (Common Pilot Channel) that is used to transmit signals with which for example a terminal searches for a cell and estimates a channel and whose transmission power is set to nearly the sum of transmission powers of PCCPCH, SCCPCH, AICH, and PICH (FIG. 8a (5)), and

DPCH (Dedicated Physical Channel) that is used to transmit down-bound speech signals (data) and whose transmission power is varied by a transmission power control preformed in association with a terminal (FIG. 8a (6)).

[Up-Bound Radio Channels]

DPCH (Dedicated Physical Channel) that is used to transmit up-bound speech signals (data) and whose transmission power is varied by a transmission power control performed in association with a terminal (FIG. 8b),

In the following description, radio channels other than DPCH of the down-bound radio channels are referred to as common control channels.

As the number of terminals that are remote from the radio base station increases, the transmission powers of the up-bound and down-bound DPCHs increase by a transmission power control. The total output (including the common control channels and DPCH) of the radio base station 71 can be approximately expressed by (output powers of common control channels×(1/(1−load ratio)). The load ratio is the ratio of the output power that is substantially transmitted by the radio base station 71 and the upper limit value of the transmission power that the radio base station 71 can transmit.

In a situation of which the load ratio may exceed a predetermined threshold value (in this example, for simplicity, it is assumed that the threshold value is 80 percent), a channel control (including an allocation of DPCH) that needs to be performed to complete a new call is not preformed.

However, in the foregoing related art, when many terminals that are located in the blind zone 73 transmit signals, the minimum level of upstream signals that the radio base station 71 can receive (hereinafter, this level is simply referred to as the minimum level) increases as the number of the terminals increases (the load ratio increases).

Thus, in this situation, it is difficult to normally receive signals from terminals that are located outside the blind zone 73, but in the wireless zone 72. Occasionally, communication cannot be made in a wider area than the blind zone 73.

As the radio base station accommodates unlimitedly many terminals, transmission quality and service quality deteriorate. To prevent these problems, with a function that refuses a connection of a terminal in the case that the reception power of the radio base station 71 exceeds a threshold value, the terminal may be excluded from a communication service. This function is referred to as admission.

When the number of radio channels allocated to terminals reaches the upper limit value, a terminal that is not located in the blind zone 73, but close to the radio base station 71 (hereinafter this area is referred to as non-blind zone), the terminal may be excluded from the communication service.

In addition, when the total power that the radio base station 71 can transmit nearly reaches the upper limit value, terminals may be excluded from the communication service.

The above-described prior art examples are disclosed in the following documents:
1. Japanese Unexamined Patent Application Publication No. 2000-333257 (abstract)
2. Japanese Unexamined Patent Application Publication No. HEI 10-22895 (abstract)
3. Japanese Unexamined Patent Application Publication No. 2000-31879 (abstract)
4. Japanese Unexamined Patent Application Publication No. 2001-333009 (abstract, claim 1, paragraphs 0001 and 0002)
5. Japanese Unexamined Patent Application Publication No. HEI 6-268574 (abstract)
6. Japanese Unexamined Patent Application Publication No. 2001-160984 (abstract)

### SUMMARY OF THE INVENTION

An object of the present invention is to provide a repeater that is capable of properly allocating a radio resource to a blind zone and a non-blind zone without having a complex structure.

Another object of the present invention is to properly maintain transmission quality and service quality of all of areas and terminals, flexibly handle the distribution of traffic that varies time by time, and improve total reliability.

Another object of the present invention is to lighten restriction on the selection of a site at which a repeater according to the present invention is installed.

Another object of the present invention is to labor-save maintenance and operation works for the repeater and reduce the cost therefor as well as to standardize the structure thereof.

Another object of the present invention is to prevent service quality and reliability from deteriorating resulting from frequent variation of the level of a first radio frequency signal that is reradiated.

Another object of the present invention is to easily and accurately check characteristics and level diagrams of individual units that contribute to reradiation of the first radio frequency signal, when the repeater according to the present invention is installed, maintained, and operated.

Another object of the present invention is to prevent interference and disturbance from occurring resulting from an excessively high level of a retransmitted first radio frequency signal and to prevent a radio resource from being unnecessarily occupied resulting from an excessively low level of the first radio frequency signal.

Another object of the present invention is to allocate a radio resource not only to the foregoing zones but a zone in which a radio transmission path is formed such that the smaller the remainder of the radio resource is, the smaller the allocated radio resource is.

Another object of the present invention is to prevent service quality and reliability from deteriorating resulting from frequent variation of the level of a retransmitted second radio frequency signal.

Another object of the present invention is to easily and accurately check characteristics and level diagrams of individual units that contribute to retransmission of the second radio frequency signal, when the repeater according to the present invention is installed, maintained, and operated.

Another object of the present invention is to prevent interference and disturbance from occurring resulting from an excessively high level of a retransmitted second radio frequency signal and to prevent a radio resource from being unnecessarily occupied resulting from an excessively low level of the second radio frequency signal.

The foregoing objects can be accomplished by a repeater which sets a gain of a retransmission unit to a small value when detecting a large load of a transmission source of a first radio signal received through a radio transmission path.

The repeater effectively narrows the wireless zone extended by the retransmission of the first radio signal as the level of the first radio signal that arrives through the original radio transmission path increases. In contrast, the repeater widens the wireless zone as the level of the first radio signal decreases. In addition, as the remainder of the power that a transmitting end of the first radio signal can transmit decreases, the repeater decreases a power allocated to the zone.

In addition, the foregoing objects can be accomplished by a repeater which maintains a gain of a retransmission unit to such a value that deterioration of transmission quality due to a retransmitted first radio signal is allowable in a wireless zone in which a radio transmission path is formed. The repeater can properly allocate the radio resource to the extended wireless zone without deteriorating desired transmission quality.

The foregoing objects can be accomplished by a repeater which monitors a level of a first radio signal received through an entire band in which occupied band(s) of the first radio signal can be included. The repeater can secure a band of a radio signal reradiated by itself without changing the structure thereof, even if the band is extended, as long as the band is known.

The foregoing objects can be accomplished by a repeater which keeps the gain of the retransmission unit at a predetermined value or suspends updating of the gain according to an instruction from exterior. The repeater can keep the gain of the retransmission unit constant regardless of the level of the first radio signal.

The foregoing objects can be accomplished by a repeater which does not retransmit the first radio signal when a reception level of the first radio signal is not in a predetermined range. When the level of the first radio signal is an improper value outside the predetermined range, the repeater does not retransmit the first radio signal.

The foregoing objects can be accomplished by a repeater which sets a gain of the retransmission unit to a small value when detecting a high level of a second radio signal received. In such a repeater, it is assumed that the level of the second radio signal is larger than that of the first radio signal due to transmission losses in the region from the foregoing extended wireless zone to the repeater according to the present invention. However, as well as the level of the first radio signal, the level of the second radio signal increases as a remaining radio resource at the transmitting end of the first radio signal decreases.

The foregoing objects can be accomplished by a repeater which retransmits the second radio signal to a transmitting end of the first radio signal at a level which decreases as a reception level of the second radio signal increases. In such a repeater, it is assumed that the level of the second radio signal is larger than that of the first radio signal due to transmission losses in the region from the foregoing extended wireless zone to the repeater according to the present invention. However, as well as the level of the first radio signal, the level of the second radio signal increases as a remaining radio resource at the transmitting end of the first radio signal decreases.

The foregoing objects can be accomplished by a repeater which keeps a gain of the relay unit at a predetermined value or suspends updating of the gain according to an instruction from the exterior. The repeater keeps the gain of the relaying unit constant regardless of the level of the second radio signal.

The foregoing objects can be accomplished by a repeater which does not retransmit the second radio signal when the reception level of the second radio signal is not in a predetermined range. The repeater does not retransmit the second radio signal that arrives from the foregoing extended wireless zone when the level thereof is an improper value outside the predetermined range.

The summary of the present invention is as follows.

A first repeater according to the present invention has a first monitor unit, a transmission unit, and a control unit. The first monitor unit monitors a first radio signal received through a radio transmission path. The retransmission unit retransmits the first radio signal. The control unit decreases an output power of the retransmission unit by setting a gain thereof to a small value, when the first monitor unit detects a large load of a transmission source of the first radio signal.

The repeater effectively narrows the wireless zone extended by the retransmission of the first radio signal as the level of the first radio signal that arrives through the original radio transmission path increases. In contrast, the repeater widens the wireless zone as the level of the first radio signal decreases. In addition, as the remainder of the power that a transmitting end of the first radio signal can transmit in parallel decreases, the repeater decreases a power allocated to the extended wireless zone. Thus, the repeater more properly allocates the radio resource to the extended wireless zone and the region in which the first radio signal directly arrives from the transmitting end of the first radio signal than the prior art examples.

In a second repeater according to the present invention the first monitor unit monitors the first radio signal of which the control unit has made the gain control, when the control unit controls the gain of said retransmission unit so that a signal of a channel on which transmission power is not dynamically controlled is to have a predetermined value. The repeater properly allocates the radio resource to both the foregoing region and the extended wireless zone without deteriorating a desired transmission quality. Thus, high service quality is maintained as well as high reliability of the radio transmission path.

In a third repeater according to the present invention the first monitor unit monitors a level of a first radio signal received through an entire band in which occupied band(s) of the first radio frequency signal can be included. In other words, it is possible to secure, without changing the structure thereof, a band of a radio frequency signal reradiated to the wireless zone to be extended by the repeater, even if the band is extended, as long as it is known. Thus, labor-saving of the maintenance and operation works for the repeater and the cost reduction can be achieved as well as the standardization of the structure of the repeater.

In a fourth repeater according to the present invention the control unit keeps the gain of the retransmission unit at a predetermined value or suspends updating of the gain according to an instruction from the exterior. In other words, the gain of the retransmission unit is kept constant regardless of the level of the first radio signal that arrives through the radio transmission path. Accordingly, it is possible to easily and accurately check characteristics and level diagrams of individual units that contribute to reradiation of the first radio frequency signal, when the repeater according to the present invention is installed, maintained, and operated.

In a fifth repeater according to the present invention the first monitor unit determines whether a reception level of the first radio signal is in a predetermined range. The retransmission unit does not retransmit the first radio signal when the reception level is not in the predetermined range. In other words, when the level of the first radio signal that arrives through the radio transmission path is an improper value outside the predetermined range, the first radio signal is not reradiated. Thus, it is possible to prevent interference and disturbance from occurring resulting from an excessively high level of the reradiated first radio signal as well as to prevent unnecessary occupation of a radio resource resulting from an excessively low level of the first radio signal.

In a sixth repeater according to the present invention a second monitor unit monitors a received second radio signal. The control unit decreases an output power of the retransmission unit by setting a gain thereof to a small value, when the second monitor unit detects a high level of the second radio signal. It is assumed that the level of the second radio signal is higher than that of the first radio signal due to transmission losses in the region from the foregoing extended wireless zone to the repeater according to the present invention. However, as well as the level of the first radio signal, the level of the second radio signal increases as the remaining radio resource of the transmitting end of the first radio signal decreases.

Thus, the radio resource is properly allocated to the foregoing extended wireless zone and the region in which the first radio signal directly arrives from the transmitting end of the first radio signal.

In a seventh repeater according to the present invention a relay unit retransmits, through the radio transmission path, the second radio signal to a transmitting end of the first radio signal at a level which lowers as a reception level of the second radio signal increases. It is assumed that the level of the second radio signal is higher than that of the first radio signal due to transmission losses in the region from the foregoing extended wireless zone to the repeater according to the present invention. However, as well as the level of the first radio signal, the level of the second radio signal increases as the remaining radio resource of the transmitting end of the first radio signal decreases.

Thus, it is possible to allocate a radio resource not only to the foregoing area but an region in which a radio transmission path is originally formed such that the smaller the remainder of the radio resource is, the smaller the allocated radio resource is.

In an eighth repeater according to the present invention the control unit keeps a gain of the relay unit at a predetermined value or suspends updating of the gain according to an instruction from the exterior. In other words, the gain of the relaying unit is kept constant regardless of the level of the second radio frequency signal. Thus, it is possible to easily and accurately check characteristics and level diagrams of individual units that contribute to retransmission of the second radio signal when the repeater according to the present invention is installed, maintained, and operated.

In a ninth repeater according to the present invention the second monitor unit determines whether the reception level of the second radio signal is in a predetermined range. The relay unit does not retransmit the second radio signal when the reception level thereof is not in the predetermined range. In other words, when the level of the second radio signal that arrives from the foregoing region is an improper value outside the predetermined range, the second radio signal is not retransmitted.

Thus, it is possible to prevent interference and disturbance from occurring resulting from an excessively high level of the retransmitted second radio signal as well as to prevent unnecessary occupation of a radio resource resulting from an excessively low level of the second radio signal.

### BRIEF DESCRIPTION OF DRAWINGS

The nature, principle, and utility of the invention will become more apparent from the following detailed description when read in conjunction with the accompanying drawings in which like parts are designated by identical reference numbers, in which:

FIG. 1 is a schematic diagram showing first and third to fifth embodiments of the present invention.

FIG. 2 is a schematic diagram showing a structure of a conversion table.

FIG. 3 is a schematic diagram (1 ) showing a structure of a load ratio table.

FIG. 4 is a schematic diagram (2) showing a structure of a load ratio table.

FIG. 5 is a schematic diagram showing a second embodiment of the present invention.

FIG. 6 is a schematic diagram showing another structure of the first to fifth embodiments of the present invention.

FIG. 7 is a schematic diagram showing an example of a structure of a CDMA mobile communication system that is provided with a repeater.

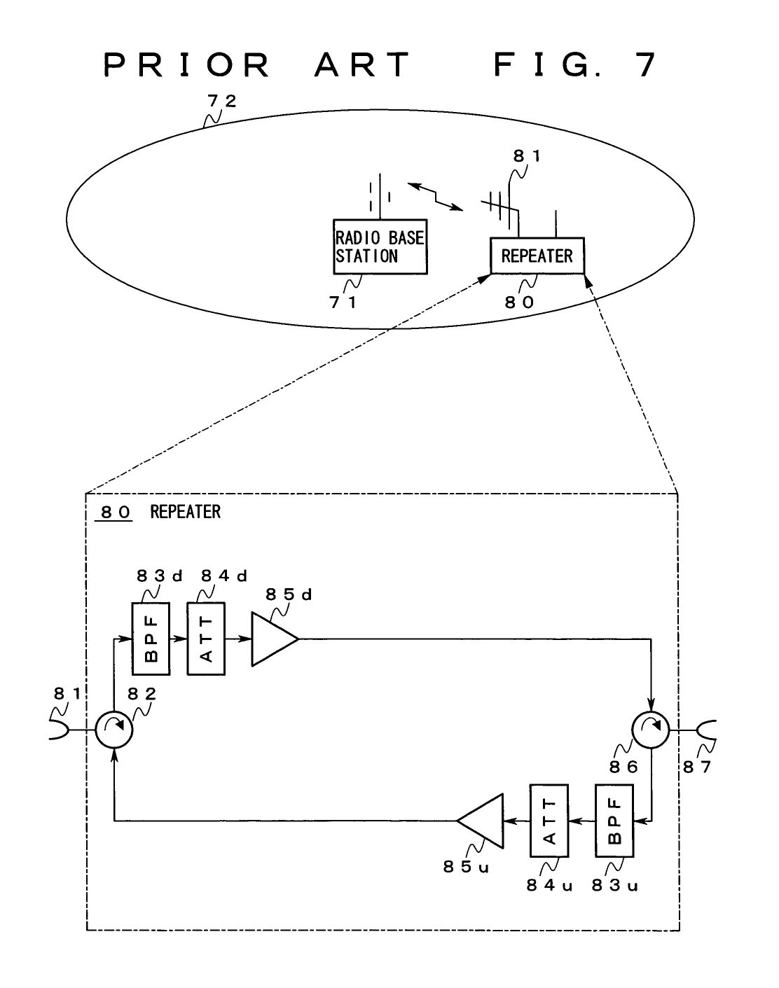

FIGS. 8a and 8b are schematic diagrams showing a structure of channels.

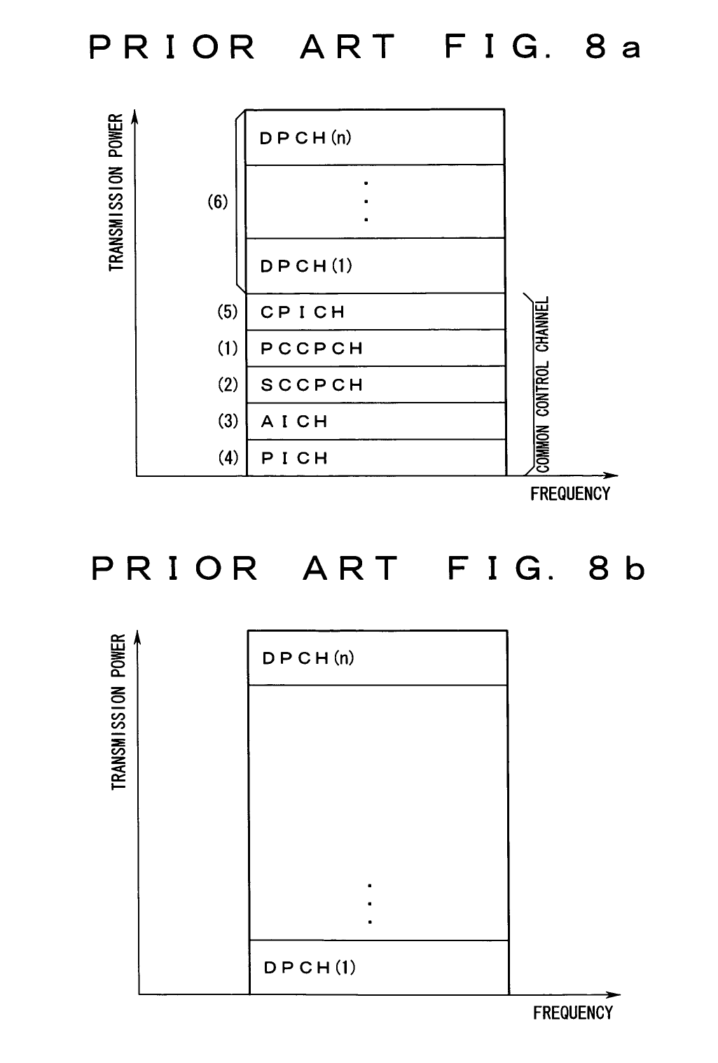

### DESCRIPTION OF THE PREFERRED EMBODIMENTS

Next, with reference to the accompanying drawings, embodiments of the present invention will be described.

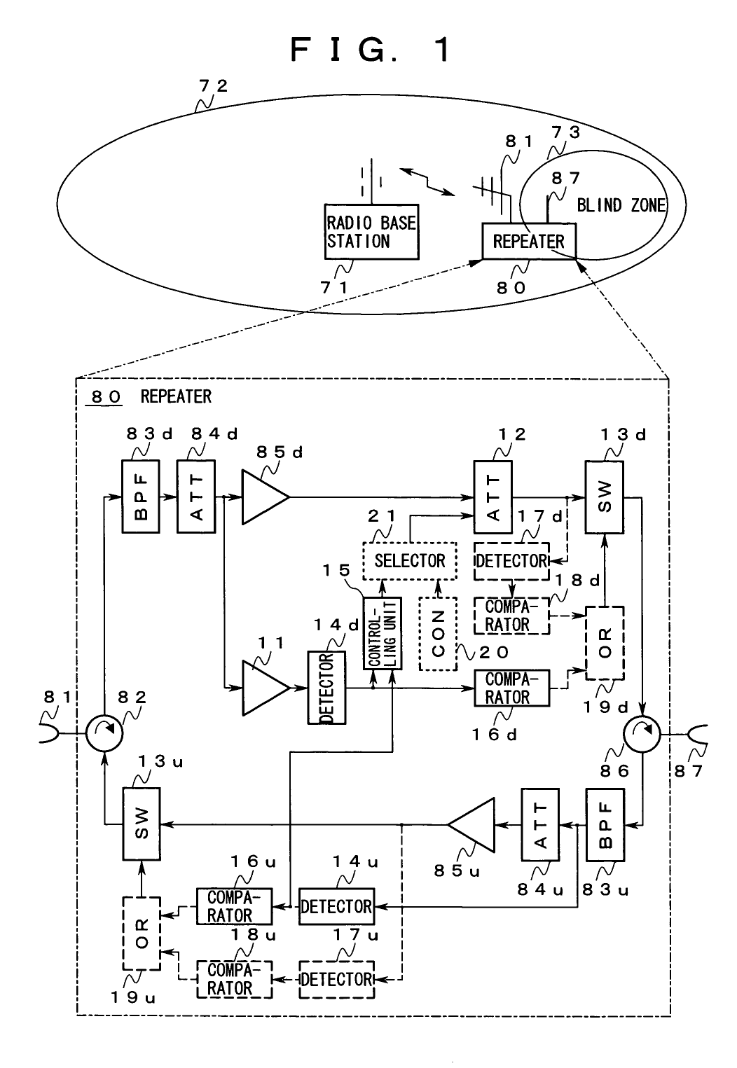

FIG. 1 is a schematic diagram showing first and third to fifth embodiments of the present invention.

In the drawing, an output of a variable attenuator 84d is connected to an input of a power amplifier 85d and an input of a power amplifier 11 that has the same characteristic and gain as those of the power amplifier 85d. An output of the power amplifier 85d is connected to a first opening of a circulator 86 through a variable attenuator (ATT) 12 and a switch (SW) 13d that are tandem-connected. An output of the power amplifier 11 is connected to a first input of a controlling unit 15 and an input of a comparator 16d through a detector 14d. An output of the comparator 16d is connected to a control input of the switch 13d (in this drawing, an output of the comparator 16d is connected to a control input of the switch 13d through an OR gate 19d. However, in this example, it is assumed that the output of the comparator 16d is directly connected to the switch 13d). An output of a band-pass filter 83u is connected to an input of a variable attenuator 84u and an input of a detector 14u. An output of a power amplifier 85u is connected to a third opening of a circulator 82 through a switch 13u. An output of the detector 14u is connected to a second input of the controlling unit 15 and a control input of the switch 13u through a comparator 16u (in this drawing, an output of the comparator 16u connected to a control input of the switch 13u through an OR gate 19u. However, in this example, it is assumed that the output of the comparator 16u is directly connected to the switch 13u not through the OR gate 19u).

### First Embodiment

Next, with reference to FIG. 1, an operation of the first embodiment of the present invention will be described.

It is assumed that the variable attenuators 84d and 85d are controlled as described in the section of Related Art.

The power amplifier 11 amplifies downstream signals that have arrived at an antenna 81 from the radio base station 71 and that have been supplied through the circulator 82, a band-pass filter 83d, and the variable attenuator 84d. The detector 14d detects and smoothens the amplified downstream signals. As a result, the detector 14d generates down-bound detection signals whose level is proportional to the level of the downstream signals.

On the other hand, the detector 14u detects and smoothens upstream signals that have arrived at an antenna 87 from the blind zone 73 and that have been supplied through the circulator 86 and the band-pass filter 83u. As a result, the detector 14u generates up-bound detection signals whose level is proportional to the level of the upstream signals.

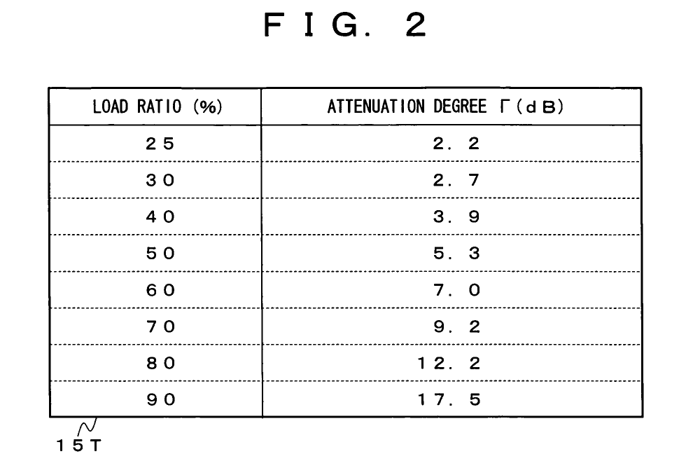

As shown in FIG. 2, the controlling unit 15 has a conversion table 15T that correlatives the foregoing load ratio and attenuation degree to be set to the variable attenuator 12 corresponding to the load ratio. The attenuation degree is set so that the area of the wireless zone 72 is narrowed. The attenuation degree is proportional to the reception level of the downstream signals.

In addition, the controlling unit 15 performs the following processes on the basis of the contents of the conversion table 15T and the foregoing down-bound detection signals and up-bound detection signals.

The controlling unit 15 obtains the level of the downstream signals and the level of the upstream signals.

The controlling unit 15 converts the level of the downstream signals into a level corresponding to the foregoing load ratio (in this example, it is assumed that the load ratio is 25 percent) and obtains a value Γ (in this example, 2.2 dB) of the attenuation degree field corresponding to or close to the load ratio field in the conversion table 15T.

The controlling unit 15 sets the attenuation degree Γ to the variable attenuator 12.

Next, various values used to compute the attenuation degree Γ that can be set to the variable attenuator 12 will be exemplified.

When radio channels that the radio base station 71 are transmitting are only common control channels, the transmission power of CPICH is equivalent to around half the transmission power of the common control channels. The transmission power of the common control channels is for example equivalent to around 25 percent of the maximum transmission power that the radio base station 71 can transmit. Thus, when the maximum transmission power that the radio base station 71 can transmit is 16 watts, the transmission power of the common control channels is 4(=16×0.25) watts. In addition, the transmission power of CPICH is 2(≈4×0.5) watts (=33 dBm).

When the level of a component of the downstream signals that are received through CPICH and that are obtained at the output of the variable attenuator 84d (in this example, for simplicity, it is assumed that the level is −100 dBm) and the transmission power (=33 dBm) of CPICH are known through measurements or theoretically, it can be estimated that the transmission loss in the radio transmission path from the radio base station 71 to the antenna 81 is 133 dB (=33 dBm−(−100 dBm)).

When the sum of the powers of the downstream signals obtained at the output of the variable attenuator 84d is for example −97 dBm, the sum of the transmission power transmitted from the radio base station 71 can be estimated as 36 dBm (=4 watts) that is equivalent to the difference between the sum of the powers of the downstream signals and the transmission loss (=133 dB).

The physical definition and the basis of computation of the attenuation degree Γ set to the variable attenuator 12 are as follows.

When it is assumed that terminals are equally distributed in the wireless zone 72, by substantially narrowing the blind zone 73, the number of terminals that access the radio base station 71 through the repeater 80 indirectly decreases.

In addition, when the transmission power of the common control channels decreases and the transmission quality thereof deteriorates, the blind zone 73 is substantially narrowed.

When the load ratio is 25 percent, by substantially narrowing the area of the blind zone 73 by 25 percent, the overload state is indirectly lightened and solved.

The narrowing of the blind zone 73 by 25 percents is equivalent to a decrease of the maximum transmission distance that secures the foregoing transmission quality by 0.866(=1−0.25)1/2).

Assuming that the transmission loss of the blind zone 73 is proportional to distance^{3.5}, an increase of the transmission loss by 2.2(≈−35 Log(0.866)) dB results in an indirect decrease of the number of terminals that can access the radio base station through the repeater 80.

Thus, the downstream signals that have arrived at the antenna 81 from the radio base station 71 are reradiated to the blind zone 73 in a level reversely proportional to the level of the downstream signals.

The comparator 16d compares the down-bound detection signals with a predetermined threshold value (it is assumed that the threshold value is equivalent to 80 percent to 90 percent load ratio. While the level of the down-bound detection signals exceeds the predetermined threshold value, the comparator 16d turns on the switch 13d.

In addition, the comparator 16u compares the level of the up-bound detection signals and the predetermined threshold value. While the level of the up-bound detection signal exceeds the threshold value, the comparator 16u turns on the switch 13u.

In other words, when the downstream signals of a level that exceeds the foregoing threshold value arrive at the antenna 81, the downstream signals are not reradiated to the blind zone 73.

In addition, when the upstream signals of a level that exceeds the foregoing threshold value arrive at the antenna 87, the upstream signals are not retransmitted to the radio base station 71.

Thus, according to this embodiment, a situation of which the radio resource is allocated to a terminal located in the blind zone 73 with priority can be prevented in comparison with the case of the related art of which signals are reradiated and retransmitted regardless of the level of the upstream signals that arrive from the radio base station 71.

Thus, the radio resource can be properly allocated to the blind zone 73 and the non-blind zone. In addition, any terminals that are located in the wireless zone 72 and the non-blind zone can be provided with almost the same communication service almost in the same service quality.

According to this embodiment, the attenuation degree Γ of the variable attenuator 12 is obtained with reference to the conversion table 15T on the basis of the level of the downstream signals.

However, with respect to the attenuation degree Γ, by comparing the level of the downstream signals and the level of the upstream signals, the signals of the higher level than the others may be referenced. In this case, a problem of which since terminals are concentrated in the vicinity of a peripheral portion of the wireless zone 72, even if the number of these terminals is small, the load ratio increases (namely, the transmission power that the radio base station 71 needs to transmit increases) can be flexibly solved.

However, the process that converts the level of the upstream signals into the load ratio can be accomplished as the following processes under the assumption of which for example the level of the upstream signals becomes higher than the level of the downstream signals by a value equivalent to the transmission losses from the blind zone 73 to the repeater 80.

(1) The controlling unit 15 has transmission power Pref of the upstream signals to be transmitted by the repeater 80 in the state that the load ratio Lu of the up link is 0 percent as a known value or a value measured in a test mode or the like.

(2) In addition, the controlling unit 15 identifies the transmission power P of the upstream signals transmitted to the radio base station 71 (the transmission power P can be identified as a conversion value of the attenuation degree set to the variable attenuator 12) and computes the load ratio Lu as a value that satisfies the following formula with respect to the transmission power P.
10·log {1/(1−Lu)}=10·log(P/Pref)

The foregoing transmission power Pref is given by the following formula with respect to the load ratio Lu of the up link and the level Nt of heat noise generated by a receiver installed in the radio base station 71 and can be computed as the difference (=23 dBm) between the minimum level L of the upstream signals received by the radio base station 71 (in this example, for simplicity, it is assumed that the level L is −110 dBm) and the transmission loss (=−133 dB).
L=Nt/(1−Lu)

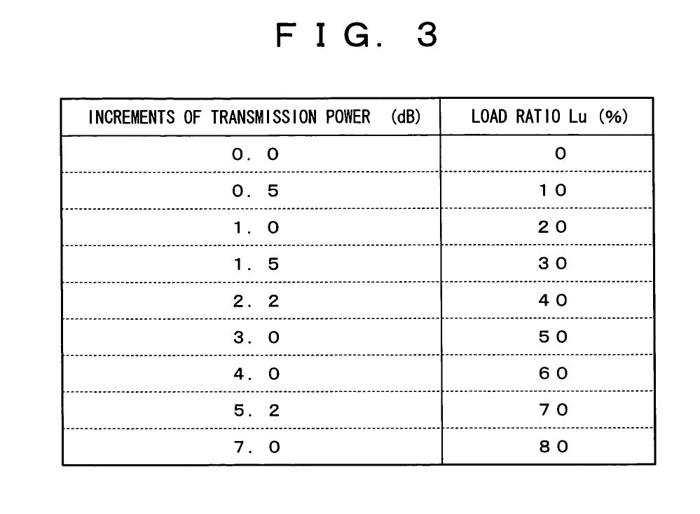

As shown in FIG. 3, the load ratio Lu (percent) of the up link may be given as a load ratio table that correlates increments of transmission power to be processed (=10·log(P/Pref)) and load ratios Lu and that is referenced by the controlling unit 15.

In addition, according to this embodiment, the attenuation degree that is set to the variable attenuator 84u is the same as the attenuation degree that is set to the variable attenuator 84d.

However, the present invention is not limited to such a structure. When the level diagram of the upstream signals is different from the level diagram of the downstream signals, the load ratio Lu of the up link and the load ratio Ld of the down link may be separately obtained. The conversion table 15T may be referenced on the basis of the larger load ratio Lu or Ld obtained by comparing the load ratio Lu and the load ratio Ld.

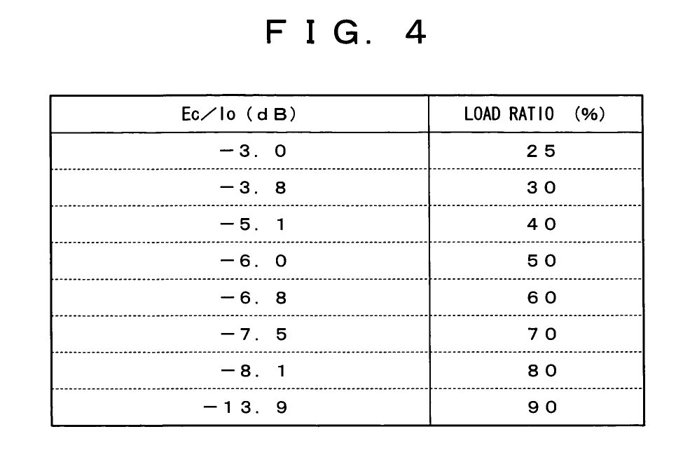

With respect to the load ratio Ld of the down link, for example (Ec/Io) of CPICH of common control channels to be transmitted in parallel with many DPCHs transmitted from the radio base station 71 is measured. As shown in FIG. 4, a load ratio table that correlates the left side and the right side of the following formula that defines (Ec/Io) (the value of the right side simply decreases corresponding to the load ratio Ld). With the measured (Ec/Io), the load ratio Ld may be obtained by referencing the load ratio table.

Ec/Io=reception power of CPICH/(all reception powers+thermal noise of repeater unit)≈transmission power of CPICH/sum of transmission powers transmitted by base station

In addition, according to this embodiment, the attenuation degree of the variable attenuator 12 is computed on the basis of the level of the downstream signals.

However, the present invention is not limited to such a structure. Instead, the attenuation amount of the variable attenuator 12 may be set in proportion to the level of the downstream signals regardless of the level of the upstream signals.

In addition, according to this embodiment, the attenuation amount of the variable attenuator 84d is preset and kept constant during maintenance and operation.

Instead, the attenuation amount of the variable attenuator 84d may be properly updated corresponding to the transmission power that varies by for example channel control, resulting in flexibility against changes of frequency allocation and channel structure.

In addition, according to this embodiment, while an instantaneous value of the down-bound detection signals exceeds the threshold value, the switch 13d is turned on. While an instantaneous value of the up-bound detection signals exceeds the threshold value, the switch 13u is turned on.

However, the present invention is not limited to such a structure. For example, when the level of the downstream signals to be reradiated and/or the level of the upstream signals to be retransmitted has no restriction, the switches 13a and 13u may be normally turned off or they may be omitted.

According to this embodiment, the load ratio is quantized as a discrete value as listed in the conversion table 15T. Thereafter, the attenuation degree Γ corresponding to the result is set to the variable attenuator 12.

However, as long as the desired accuracy and response characteristic are attained, the attenuation degree Γ may be obtained as a result or an approximate value of an arithmetic operation based on the load ratio obtained in the foregoing manner.

In addition, according to this embodiment, no restriction is imposed onto the attenuation degree Γ to be set to the variable attenuator 12.

However, as long as characteristic errors including isolation between the input terminal and the output terminal of the variable attenuator 12 are permitted, the following restrictions may not be imposed onto the attenuation degree Γ.

The maximum attenuation amount is restricted to a predetermined value (for example ten and several decibels) or less.

When the load ratio is the predetermined value (for example, 80 percent) or larger, the attenuation amount is kept to the predetermined upper limit value.

### Second Embodiment

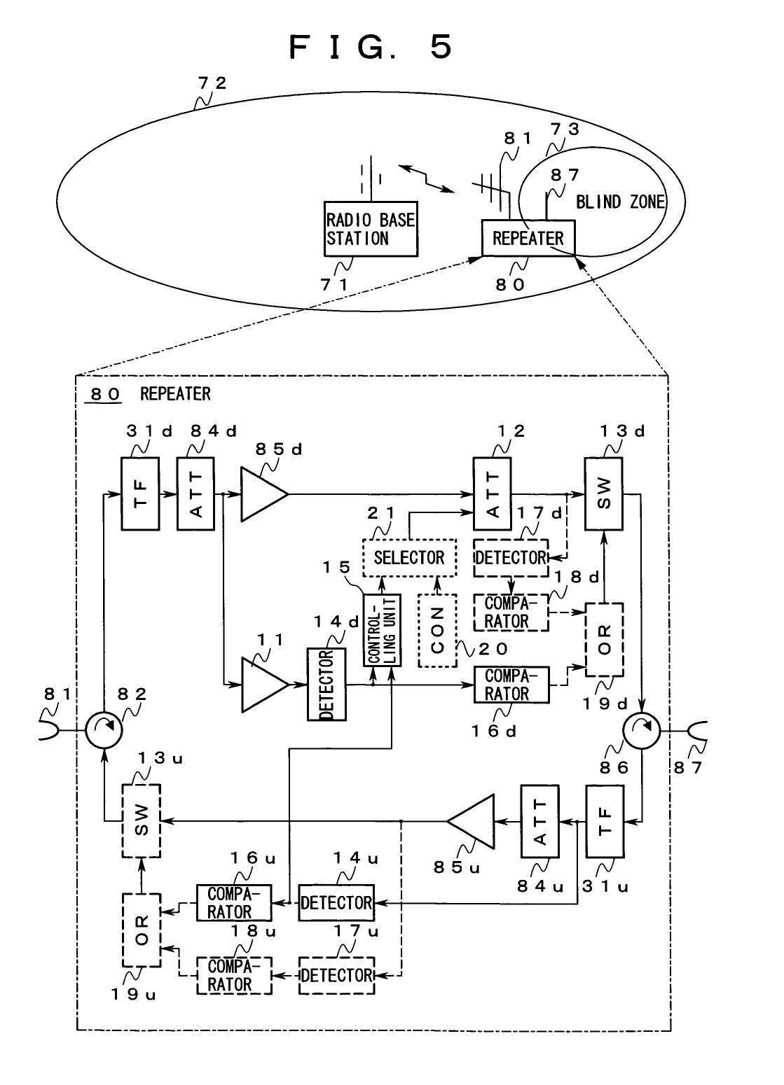

FIG. 5 is a schematic diagram showing a second embodiment of the present invention.

According to this embodiment, tunable filters (TF) 31d and 31u are provided instead of the band-pass filters 83d and 83u shown in FIG. 1, respectively.

Next, with reference to FIG. 5, the second embodiment of the present invention will be described.

The pass band of the tunable filter 31d is preset to a band equivalent to an occupied band of downstream signals that arrive from the radio base station 71 and that are reradiated to the blind zone 73 (the occupied band is not limited to a single band, but a plurality of bands allocated to the radio base station 71 (wireless zone 72) corresponding to a desired frequency allocation.

On the other hand, the pass band of the tunable filter 31u is preset to a band equivalent to an occupied band of upstream signals that arrive from the blind zone 73 and that are retransmitted to the radio base station 71 (the occupied band is not limited to a single band, but a plurality of bands allocated to the radio base station 71 (wireless zone 72) corresponding to a desired frequency allocation).

Thus, according to this embodiment, as the traffic and the number of subscribers increase, even if a plurality of radio frequencies are in parallel allocated to the radio base station 71, they can be flexibly extended in various frequency allocations.

According to this embodiment, even if there are a plurality of bands shared according to the CDMA (Code Division Multiple Access) scheme, the attenuation degree to be given to the variable attenuator 12 is preset by a common circuit (including the controlling unit 15).

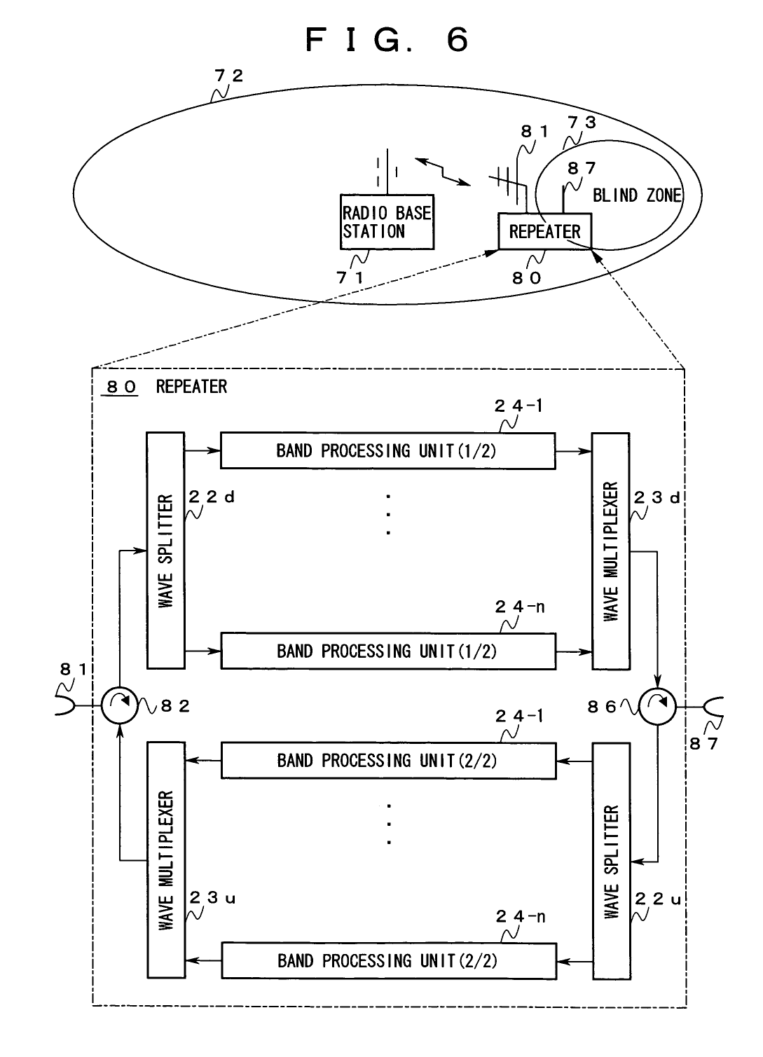

However, the present invention is not limited to such a structure. For example, as shown in FIG. 6, with the following elements, the foregoing processes may be preformed for each band.

Wave splitters 22d and 22u whose inputs are connected to the first opening of the circulator 82 and the third opening of the circulator 86, respectively,

Wave multiplexers 23d and 23u whose outputs are connected to the third opening of the circulator 82 and the first opening of the circulator 86, respectively,

A plurality (n) of band processing units 24-1 to 24-n that are composed of elements other than the circulators 82 and 86 shown in FIG. 1, that have different pass bands of band-pass filters 83d and 83u, and that are disposed between the corresponding outputs of the wave splitters 22d and 22u and the corresponding inputs of the wave multiplexers 23d and 23u.

### Third Embodiment

Next, with reference to FIG. 1, a third embodiment of the present invention will be described.

This embodiment features the characteristics of the comparators 16d and 16u and the following operations that they perform.

In the following description, since the characteristics and operations of the comparators 16d and 16u are the same, they will be described with respect to only the comparator 16d.

When an instantaneous value of the up-bound detection signals exceeds a predetermined threshold value (=th1), the comparator 16d turns on the switch 13d, preventing the upstream signals from being reradiated to the blind zone 73.

Even if an instantaneous value of the up-bound detection signals decreases to the foregoing threshold value thy, the comparator 16d keeps the switch 13d on. When an instantaneous value becomes smaller than threshold value th2 that is smaller than the threshold value thy, the comparator 16d turns off the switch 13d.

In other words, the reradiation of the downstream signals is stably restricted even if the instantaneous value of the down-bound detection signal exceeds the threshold value th1 and increases/decreases, unless the instantaneous value does not become smaller than the threshold value th2 (<th1).

Thus, according to this embodiment, degradation of service quality and reliability and unnecessary increase of power consumption resulting from reradiation of the downstream signals or retransmission of the upstream signals that is frequently performed can be prevented.

In addition, according to this embodiment, the comparators 16d and 16u each have a hysteresis characteristic.

However, this hysteresis characteristic may be provided in one of the comparators 16d and 16u.

In addition, according to this embodiment, the hysteresis characteristic is accomplished as input/output characteristics of the comparators 16d and 16u.

Instead, the hysteresis characteristic may be accomplished by any circuit such as a timer circuit that sets a desired value or larger for the minimum intervals of open/close of the switch 13d (14u) or through software.

### Fourth Embodiment

As represented by dotted lines shown in FIG. 1, according to this embodiment, the following elements are provided.

A detector 17d connected to an input of the switch 13d and an output of the variable attenuator 12,

A comparator 18d tandem-connected to an output of the detector 17d,

An OR gate 19d whose first input is connected to an output of the comparator 18d, whose second input is connected to an output of the comparator 16d, and whose output is connected to a control input of the switch 13d,

A detector 17u whose input is connected to the input of the switch 13u and the output of the power amplifier 85u,

A comparator 18u tandem-connected to an output of the detector 17u, and

an OR gate 19u whose first input is connected to an output of the comparator 18u, whose second input is connected to the output of the comparator 16u, and whose output is connected to the control input of the switch 13u.

Next, with reference to FIG. 1, an operation of the fourth embodiment will be described.

The detector 17d detects and smoothens the downstream signals supplied from the output of the power amplifier 85d through the variable attenuator 12. As a result, the detector 17d generates down-bound monitor signals that represent the power of the downstream signals as a sequence of instantaneous values. The comparator 18d compares an instantaneous value of the down-bound monitor signals with a predetermined upper limit value. While the former exceeds the latter, the comparator 18d turns on the switch 13d through the OR gate 19d.

On the other hand, the detector 17u detects and smoothens the upstream signals that are output from the power amplifier 85u. As a result, the detector 17u generates up-bound monitor signals that represent the power of the upstream signals as a sequence of instantaneous values. The comparator 18u compares an instantaneous value of the upstream signals with the predetermined upper limit value. While the former exceeds the latter, the comparator 18u turns on the switch 13u through the OR gate 19u.

In other words, even if any trouble occurs in a region from the feeding point of the antenna 81 to the output of the variable attenuator 12 through the circulator 82, the band-pass filter 83d, the variable attenuator 84d, and the power amplifier 85d (this region is hereinafter referred to as the down link processing unit, causing the level of the downstream signals to exceed the foregoing smaller limit value, the downstream signals can be prevented from being reradiated in a very large level with high possibility.

Likewise, even if any trouble occurs in a region from the feeding point of the antenna 87 to the output of the power amplifier 85u through the circulator 86, the band-pass filter 83u, and the variable attenuator 84u (this region is hereinafter referred to as up link processing unit), causing the level of the upstream signals to exceed the foregoing smaller limit value, the upstream signals can be prevented from being retransmitted in a very high level with high possibility.

Thus, in a radio communication system and a radio transmission system in which the repeater according to this embodiment is installed, transmission quality and service quality are highly maintained in comparison with the case that the downstream signals are reradiated and the upstream signals are retransmitted even if the down link processing unit and the up link processing unit normally operate.

According to this embodiment, the validities of the operations and characteristics of the down link processing unit and the up link processing unit are determined on the basis of only the downstream signals and the upstream signals.

Instead, the validities of the operations and characteristics may be determined based on the distribution of powers on the frequency axis and the distortion of the waveforms. Instead, the validities of the operations and characteristics may be determined on the basis of any criterion that needs to be satisfied for these signals according to predetermined information with respect to frequency allocation, multi-access division scheme, modulation scheme, and so forth.

### Fifth Embodiment

As represented by dotted lines of FIG. 1, according to this embodiment, the following elements are provided.

An operation and display unit (CON) 20 that is used to designate a test mode that will be described later and to set an attenuation degree ATTt that needs to be set to the variable attenuator 12 in the test mode, and

A selector 21 whose first input is connected to an output of the operation and display unit 20, whose second input is connected to an output of the controlling unit 15, and whose output is connected to a control input of the variable attenuator 12.

Next, with reference to FIG. 1, an operation of the fifth embodiment of the present invention will be described.

The operation and display unit 20 has an operation unit used to set a predetermined attenuation degree (hereinafter referred to as standard attenuation degree) to be set to the variable attenuator 12 in the test mode.

When the operation and display unit 20 causes the repeater 80 to enter the foregoing test mode with an instruction or the like, the selector 21 continues to supply the standard attenuation degree to the variable attenuator 12 instead of the attenuation degree supplied by the controlling unit 15 until the operation and display unit 20 cancels the instruction.

In other words, in the test mode (maybe in the initial setting), using a predetermined measurement instrument and tool, on the basis of the standard attenuation degree that is set through the operation and display unit 20, the foregoing threshold value, smaller limit value, and characteristics of individual units such as the variable attenuators 84d and 84u can be stably and accurately checked and calibrated.

Thus, the maintenance and operation can be labor-saved and effectively preformed with high reliability.

According to each of the foregoing embodiments, when the operation of the repeater is started, the attenuation degree of the variable attenuator 84u is set and then kept constant.

However, the present invention is not limited to such a structure. When the level of the upstream signals is variable, the attenuation degree of the variable attenuator 84u may be properly adjusted in the foregoing test mode.

According to each of the foregoing embodiments, the present invention is applied to a repeater that relieves a blind zone of a mobile communication system according to the CDMA scheme.

However, the present invention is not limited to such a repeater. For example, the present invention may be applied to a repeater that relieves a blind zone and that extends a wireless zone (service area) regardless of the zone structure, frequency allocation, and multiple access scheme when the repeater is used in a radio communication system and a radio transmission system that need to properly suppress the levels of spurious signals due to simultaneous transmission of a lot of radio channels resulting in deterioration of transmission quality and service quality.

In addition, according to each of the foregoing embodiments, the load ratio is identified on the basis of the powers of the downstream signals and the upstream signals. The attenuation degree Γ corresponding to the load ratio is set to the variable attenuator 12.

However, the present invention is not limited to such a structure. Instead, hardware that references information or the like of which a radio base station informs it under a predetermined channel control may be provided in terminals that may be located for example in the wireless zone 72 and the blind zone 73. As a result, a load ratio that is properly updated under the channel control is accurately and quickly identified in association with the hardware. Thus, deterioration of the accuracy of the load ratio, resulting from ground structures and land forms that are located between the radio base station 71 and the repeater 80, is prevented.

According to each of the foregoing embodiments, the level of the downstream signals to be reradiated is set by varying the attenuation degree of the variable attenuator 12 disposed downstream of the power amplifier 85d.

However, this level may be set by an amplifier that has functions of both the power amplifier 85d and the variable attenuator 12 and that can vary the gain.

In addition, according to each of the foregoing embodiments, the level of the downstream signals to be input to the power amplifier 85d is properly set corresponding to the attenuation degree of the variable attenuator 84d. In addition, the level of the upstream signals to be input to the power amplifier 85u is properly set corresponding to the attenuation degree of the variable attenuator 84u.

However, both or one of the variable attenuators 84d and 84u may be replaced with an amplifier that can vary the gain when the relative distance between the repeater 80 and the radio base station 71 or the relative distance between a terminal that is the closest to the repeater 80 in terminals located in the blind zone 73 and the repeater 80 varies in various manners or in a wide range.

The invention is not limited to the above embodiments and various modifications may be made without departing from the spirit and scope of the invention. Any improvement may be made in part or all of the components.

What is claimed is:

1. A repeater, comprising:
a first monitor unit which monitors a first radio signal received through a radio transmission path;
a retransmission unit which retransmits said first radio signal; and
a control unit which decreases an output power of said retransmission unit by setting of a gain thereof to a small value, when said first monitor unit detects a large load of a transmission source of said first radio signal.

2. The repeater as set forth in claim 1, wherein
when said control unit controls the gain of said retransmission unit so that a signal of a channel on which transmission power is not dynamically controlled is to have a predetermined value, said first monitor unit monitors the first radio signal of which said control unit has made the gain control.

3. The repeater as set forth in claim 1, wherein
said first monitor unit monitors a level of said first radio signal received through an entire band in which occupied band(s) of said first radio signal can be included.

4. The repeater as set forth in claim 1, wherein
said control unit keeps the gain of said retransmission unit at a predetermined value or suspends updating of the gain according to an instruction from an exterior.

5. The repeater as set forth in claim 1, wherein:
said first monitor unit determines whether a reception level of said first radio signal is in a predetermined range; and
said retransmission unit does not retransmit said first radio signal when the reception level of said first radio signal is not in the predetermined range.

6. The repeater as set forth in claim 1, further comprising
a second monitor unit which monitors a received second radio signal, wherein
said control unit decreases an output power of said retransmission unit by setting a gain thereof to a small value, when said second monitor unit detects a high level of said second radio signal.

7. The repeater as set forth in claim 1, further comprising
a relay unit which retransmits, through said radio transmission path, a second radio signal to a transmitting end of said first radio signal at a level which decreases as a reception level of the second radio signal increases.

8. The repeater as set forth in claim 6, wherein
said control unit keeps a gain of said relay unit at a predetermined value or suspends updating of the gain according to an instruction from an exterior.

9. The repeater as set forth in claim 7, wherein:
said second monitor unit determines whether the reception level of said second radio signal is in a predetermined range; and
said relay unit does not retransmit said second radio signal when the reception level of said second radio signal is not in the predetermined range.
